(19) United States
(12) Patent Application Publication
(10) Pub. No.: US 2012/0030136 A1
(43) Pub. Date: Feb. 2, 2012

(54) SYSTEM AND METHOD FOR DETERMINING COMPLIANCE WITH FEDERAL SECURITIES AND TAX LAWS FOR AN ISSUED SECURITY

(76) Inventor: Johan Rosenberg, Edina, MN (US)

(21) Appl. No.: 12/847,796

(22) Filed: Jul. 30, 2010

(51) Int. Cl. G06Q 40/00

(52) U.S. Cl. 705/36 R

(57) ABSTRACT

A computer operating system runs a computer, and executes a computerized method that includes eliciting and receiving an input to identify a selected investment, as well as an initial offering price for the investment. The operating system also finds and receives information related to trades of the identified investment after the initial offering and compares transactional information related to the trade after the initial offering to transactional information from the initial offering. The operating system generates a message when the transactional information related to the trade after the initial offering is outside a selected range from the transactional information from the initial offering. Also disclosed is a computerized method that accomplishes the method of the operating system and a computer readable media that includes a set of instructions for accomplishing the method.

### TECHNICAL FIELD

Various embodiments described herein relate to a method and a system for determining compliance with Federal securities and tax law for an issued security. More specifically, this relates to proper pricing of an issued security.

### BACKGROUND

An investment bank is a financial institution that assists corporations and governments in raising capital by underwriting and acting as the agent in the issuance of securities. Many investment banks also assist companies or governments by making a market in various securities. In other words, the investment bank may be associated with an affiliate banking operation that sells the very securities that the investment bank is underwriting.

Additionally, the investment bank assures that all the filings are correct with various government agencies regulating the underwriting and sale of investments. The investment bank also provides expertise in determining the total par amount of securities to be offered, the appropriate interest rate at which those securities will be offered and the term over which that security will be repaid.

To provide investment banking services in the United States an investment advisor associated with investment banking firm must be a licensed broker-dealer. The advisor is subject to Securities & Exchange Commission (SEC) (FINRA) regulation. Prior to 1999, the law mandated that investment banking and commercial banking be conducted by separate entities. Today, however, an investment bank can affiliate with a commercial bank. An investment bank generally receives a percentage of the total issue as a fee for its services. Commercial banks receive a fee or commission for selling investments to investors, including the very investments being underwritten by the investment bank with which it may be affiliated. The securities law attempts to prevent or curtail the investment bank or its affiliated commercial bank from making an additional profit by incorrectly pricing the investment upon initial offering with the aim of reselling that security at a higher price in the secondary market. For certain types of investments, the SEC requires that the market price of the security be as close to par as possible so as to prevent the security from being sold at a premium. When a security is sold at a premium, it is an indication that the interest rate was set too high for the initial sale of that investment. Additionally, newly created investment securities are required to be offered at par or very close to par. For example, one relatively new product is the Build America Bond that was created by the American Recovery and Reinvestment Act of 2009. This bond can only be issued by states and local governments and their political subdivisions. The interest paid to investors of these bonds is taxed by the federal government, however, a portion of the interest paid by the states and local governments and their political subdivisions that issue these bonds is rebated to the issuer. Because the federal government is rebating a portion of the interest paid on the bonds, it wants the interest rate on the bond to be as low as possible. If shortly after initial offering, these bonds are trading above par in the secondary market there is evidence to suggest that the interest rate on the bond was set too high and as such the federal government is paying a higher subsidy than had the bonds been priced correctly initially.

### BRIEF DESCRIPTION OF THE DRAWINGS

FIG. 1 is a diagrammatic representation of a computer system, according to an example embodiment.

FIG. 2 is another schematic diagram of a computer system, according to an example embodiment.

FIG. 3 is a screen shot of an active display device (input output) of a computer system, according to an example embodiment.

FIG. 4 is a screen shot of an active display device (input output) of a computer system, according to an example embodiment.

FIG. 5 is a flow diagram of a method associated with the computer system, according to an example embodiment.

FIG. 6 is a flow diagram of a method associated with the computer system, according to an example embodiment.

FIG. 7 shows a flow diagram of an optimization of a recommendation engine, according to an example embodiment.

### DETAILED DESCRIPTION

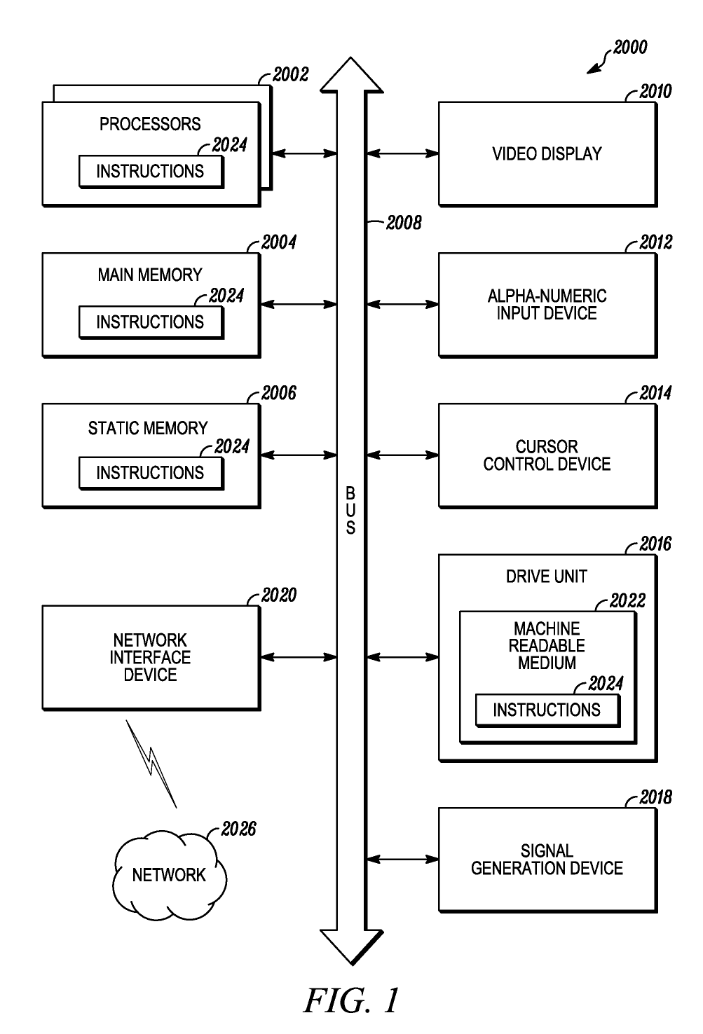

FIG. 1 shows a diagrammatic representation of a computing device for a machine in the example electronic form of a computer system 2000, within which a set of instructions for causing the machine to perform any one or more of the error correction methodologies discussed herein can be executed or is adapted to include the apparatus for error correction as described herein. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal displays (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

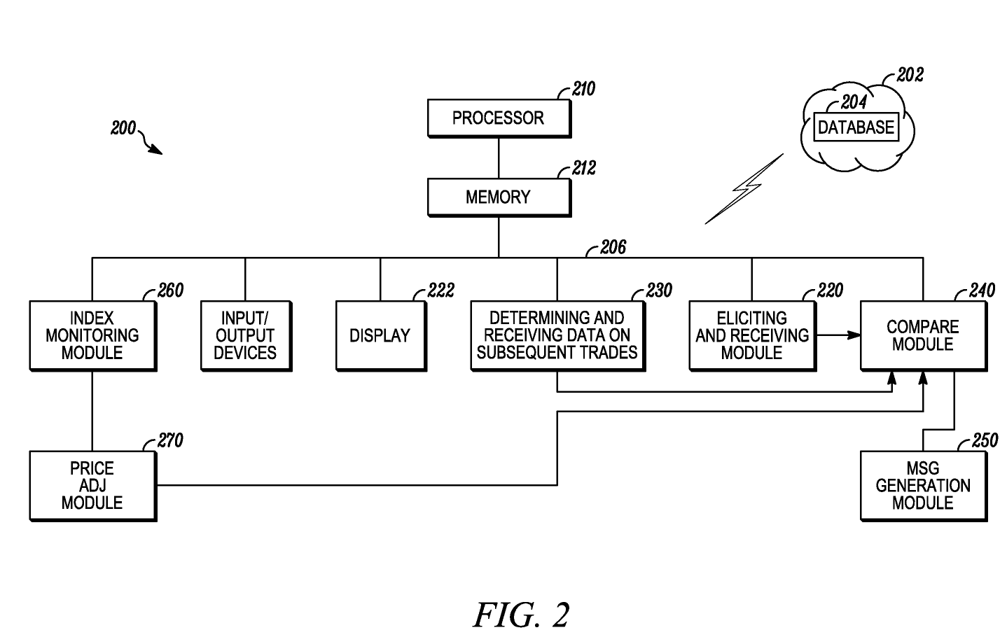

FIG. 2 is another schematic diagram of a computing system 200 that includes a plurality of modules, according to an example embodiment. In one example embodiment, the computing system 200 is formed using at least the central processing unit 2004, and the memory 2032 of the computer system 2000, as shown in FIG. 1. The memory 2032 of the computer system 2000 is used to store machine-readable instructions. The central processing unit 2030 acts in accord with the computer-readable instructions to form the various modules, according to an embodiment of the invention. A system 200 for identifying non compliant trades after for a selected time after an initial offering includes a processor 210 (such as central processing unit 2004 shown in FIG. 1), and a memory 212 (such as random access memory 2032 shown in FIG. 1) communicatively coupled to the processor 210. The system 200 includes a plurality of modules which can be formed of hardware, software or a combination of hardware and software. The modules includes an eliciting and receiving information module 220 using the processor 210 and the memory 212 to elicit and receive information to identify a selected investment, and to elicit and receive information regarding an initial offering price for the investment. The eliciting and receiving information module 220 is attached to an input device 222, such as a display that displays interactive pages. As shown in FIG. 2 the display 222 is communicatively coupled to the eliciting and receiving module 220 by way of an information and controls bus 206. The system 200 is also attached to the internet 202. As shown in FIG. 2, the eliciting and receiving information module 220 is attached to the internet 202 and more specifically to a data base 204 associated with the internet 202. The database could be on any computer or server in the cloud or on any computer having a connection with the internet through the World Wide Web. The eliciting and receiving information module 220, in one embodiment, polls one or more databases 204. The system also includes a module 230 for determining and receiving information related to at least one trade of the identified investment after an initial offering.

The system 200 also includes a compare module 240 for comparing transactional information related to the trade after the initial offering to the initial offering price, and a message generation module 250 using the processor 210 and the memory 212 when the transactional information related to the trade after the initial offering is outside a range from the initial offering. In some embodiments, the system 200 further includes a module 260 for monitoring an index on which an interest rate of the selected investment depends, and a module 270 for adjusting the initial offering price based on a change in the interest rated of the selected investment. The index monitoring module 260 monitors prices after the initial sale or initial public offering of an investment. In one embodiment, the index monitoring module 260 utilizes the internet connection and finds one or more data bases related to the index being monitored. The price adjustment module 270 calculates an adjusted sales price given a movement in the index to which a selected security is tied. The adjusted price module 270 outputs the adjusted price to the compare module 240. The compare module 250 can then also compare a range around the adjusted price to the sale price after the initial public offering. The message generator 250 will output a message indicating that the subsequent sales price is outside the range from the original sales price regardless of the outcome of the comparison of the subsequent sales price to the adjusted sales price. The comparison of the subsequent sales price to an adjusted price may be used to explain a subsequent sales price that is outside the range of the initial public offering price.

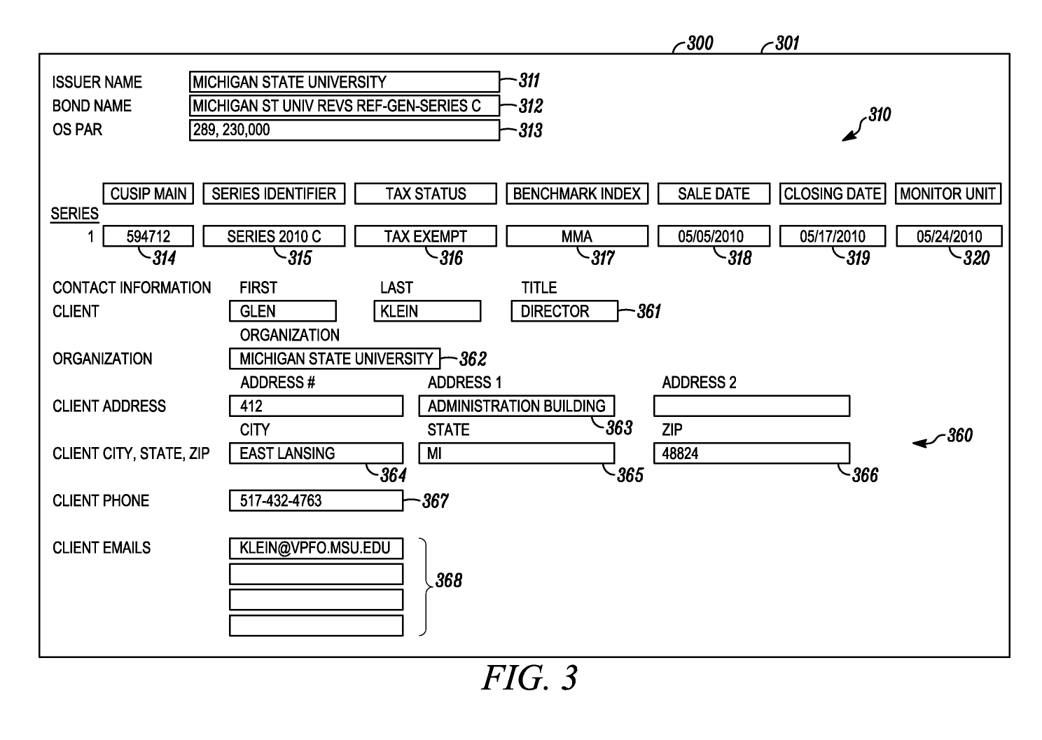

FIG. 3 is a screen shot from a display type input output device having a first group of fields 310 and a second group of fields 360, according to an example embodiment. The group of fields 310 includes an issuer name 311, a bond name 312 and a number of outstanding shares at par value field 313. The first group of fields 310 also includes additional identifiers such as a CUSIP main number field 314 and a series identifier number field 315. Also included is a filed for the tax status 316, and a benchmark index field 317. The benchmark index field 317 identifies a benchmark to which the investment is tied. For example, the investment identified is a bond which has a variable interest rate. The interest rate of the bond is tied to the interest rate of the benchmark index shown in the filed 317. The first group of fields also includes a sales date field 318, a closing date field 319 and a monitor until date field 320. The last field 320 and the sales date field set 318 form a date range for monitoring sales of the investment in a secondary market, according to one example embodiment.

The second group of fields 360 includes contact information, billing information, and E-mail information. The second set of fields also includes a client field 361 which includes a first name, last name and title for the client. The second group of fields 360 also includes an organization filed 362, a client address field 363 and a city filed 364, a state filed 365 and a zip code field 366. There is also a client phone field 367 and a current e-mails field 368. The current e-mails field 368 includes a number of different fields for e-mail addresses. These E-mails are destinations for reports, or for E-mail notification. To elicit information, any number of fields described above may be required fields. Required fields are those that are needed to identify an investment, according to an example embodiment. For example, the CUSIP Main field 314 and the series number field 315 are needed to identify the investment. These can be set up as required fields. For example, these fields could be designated as required fields by an asterisk and a comment of “required” near the field. Unless the field was filled partially or completely, a user would not be allowed to move to another webpage. Several of the other fields might include drop down menus. For example, the fields 318, 319 and 320 include dates. A drop down that includes a calendar could be used to elicit the information needed. This also is helpful in preventing date errors where an initial sales date is selected that is after a closing date for example. Other fields that can use drop down menus would include the tax status field 316. Most of the tax status designations could be placed on a drop down menu. The information as to “tax status” is elicited by having the user select one of the options presented. Once the information is elicited, the information is stored for future use. The screen shot 300 shown in FIG. 3 can be termed an account setup page which includes information about the client, and the investment and the time needed to monitor the investment.

In one embodiment, a separate account set up screen is displayed and filled out. After completion of the account set up process has been completed, the operating system will automatically display a separate investment data screen, such as depicted in FIG. 3 as screen shot 300. As shown in FIG. 3, information from the account set up screen is included on the investment data screen. The investment data screen includes a visible link for account setup (such as shown in FIG. 3) in case there is a need to make any changes or reset passwords. The investment data screen 300 also includes links for a home page and a “contact us” page. In one embodiment, the bond data input screen 300 is expandable so that multiple data inputs for various bonds can be input for monitoring. In other words, the screen shot 300 would include multiple rows of information depicted by the fields 314, 315, 316, 317, 318, 319, 320.

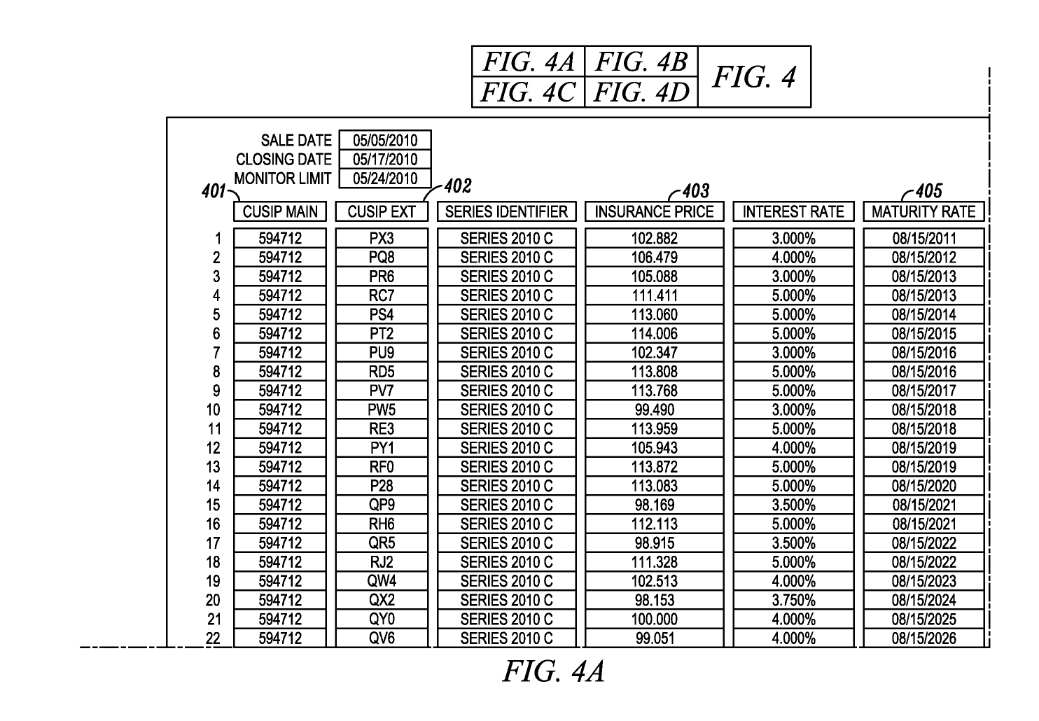

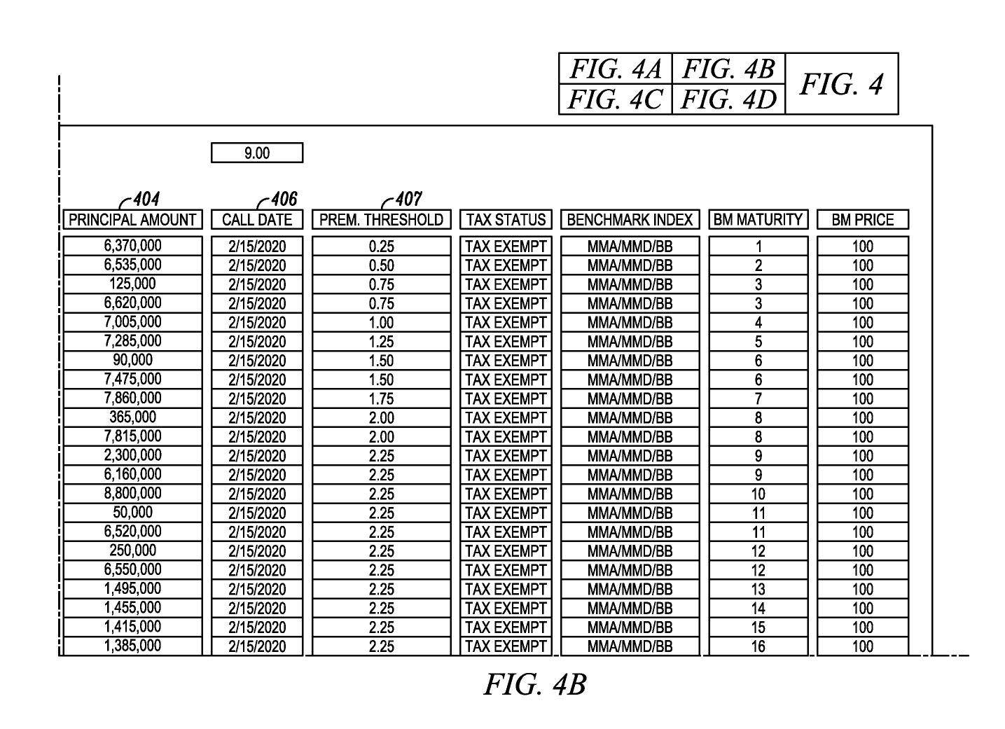

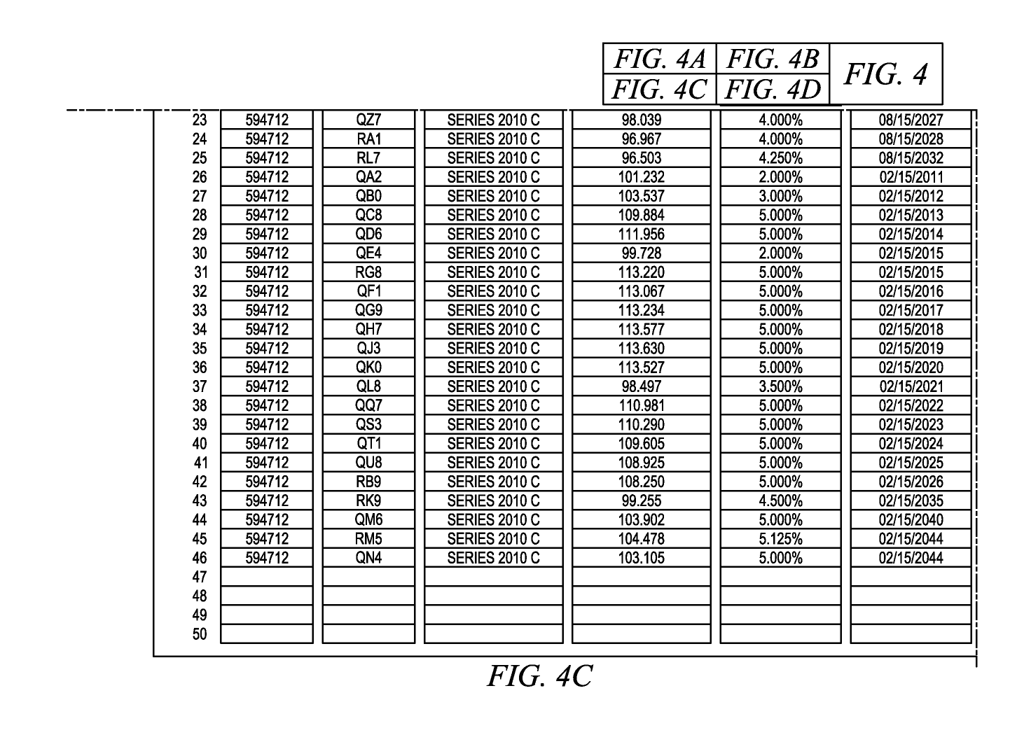

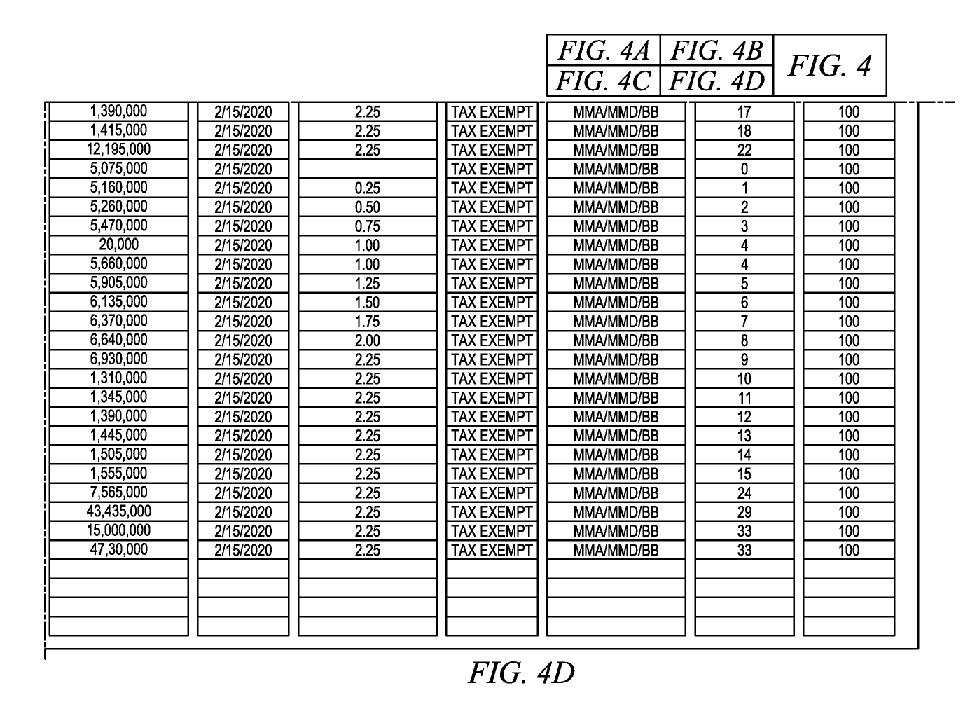

FIG. 4 is another screen shot 400 from a display type input output device that includes a field (blank) that is required to be filled according to an example embodiment. In some embodiments, a table displays information on all the investments that are being monitored, such as shown in FIG. 4. As shown in FIG. 4, all the investments which were bundled together and sold on the issue date. All have the same CUSIP Main number, as shown by field 401 but have different CUSIP Ext identifiers as shown by the different identifiers shown in a field 402. The various investments have different issuance prices, principal amounts and maturity dates, as depicted by fields 403, 404 and 405, respectively. The various investments have the same call date, as depicted by the call date field 406. Of note, is a premium threshold field 407. The premium threshold value in the field 407 varies. The value is determined by various factors (detailed below) and sets out an allowable amount of variance from the original rate of return associated with the sale as issued. For example, if the sales price in the secondary market of a bond type investment is higher than the issuance price, this will bring the interest rate down. Such a sale is an indication that the original sales price at issuance was too low for the given interest rate. Put another way, the interest rate was higher than the market rate and may have been issued with an initial sales price that was too low. This analysis is the same regardless of when the sale occurred, however, the analysis must take place on sales that are close to the issue date to determine or even give an indication that the original price at issuance may be in error. Generally, interest rates do not vary dramatically in a short time, such as two weeks to a month, after the issuance date. In another embodiment, there may be investments that issued on different dates and close on different dates that are shown on the screen shot 400. In some embodiments, there may be more than one screen of investments that are being monitored.

Other data needed for an investment data screen 400 can include the following:
a. Issuance Price—the price paid for the bond at the issue date. The default will be par; or a manually input percentage, such as 101%
b. Bond sale date—which can be elicited and received using a calendar selector
c. Bond closing date—which can be elicited and received using a calendar selector
d. Series Identifier—a manual input which may be a required field
e. Monitor until/Service end date—calendar selector, or select one-day prior to bond closing date
f. Bond Type—the options here are: Build America Bonds (Tax Credit), Build America Bonds (Direct Payment), Tax-Exempt Municipal Bonds; or Private Activity Bonds
   Benchmark Index—Tsy Index, MMD (may provide all the ones available), MMA's bond index, RBI. These will be selected from a drop down list. Another aspect provided can include the ability to choose historical time periods. We will need to identify the period of time historically that we are going to support.
g. De minimis rule No. of years calculation—Select from calculation options using: partial periods; rounded to nearest full year.

Now, referring to both FIGS. 3 and 4, the operation of the eliciting and receiving information module 220 will be further detailed. Of course, the eliciting and receiving information module 220 uses or acts through the processor 210 to elicit and receive information to identify a selected investment, and to elicit and receive information regarding an initial offering price for the investment. The eliciting and receiving information module 220 is communicatively coupled to the input device 222. As shown in FIG. 2, this input output device is a display that displays interactive pages. FIG. 3 shows one example screen shot 300 from the display 222. As shown, the screen shot is an instance in time from an account set up screen 301. The screen includes a number of required fields. The screen, which reflects a user interface, can also feature fields that are drop down menus. The drop down menus can include or can show one of several options. The screens can also include required to be filled fields which must be filled before the information can be saved or before the user can move to another screen. Drop down menus elicit information by presenting one of several choices. A user selects one of the choices or options. This of course is memorialized on the screen as the screen changes to indicate a selection has been made. Similarly, when a required field is presented, it also elicits information. The required field must be filled and this information is memorialized or placed into memory. It should be noted that the interaction through the display type input output device 222 is dynamic. The screen shot 300 shown in FIG. 3 is a snapshot in time of the dynamic input output device 222. The selection information is relayed to the eliciting and receiving module 220. The eliciting and receiving module receives the information. As shown, the options 320, 322 for the drop down menu relate to the type of investment.

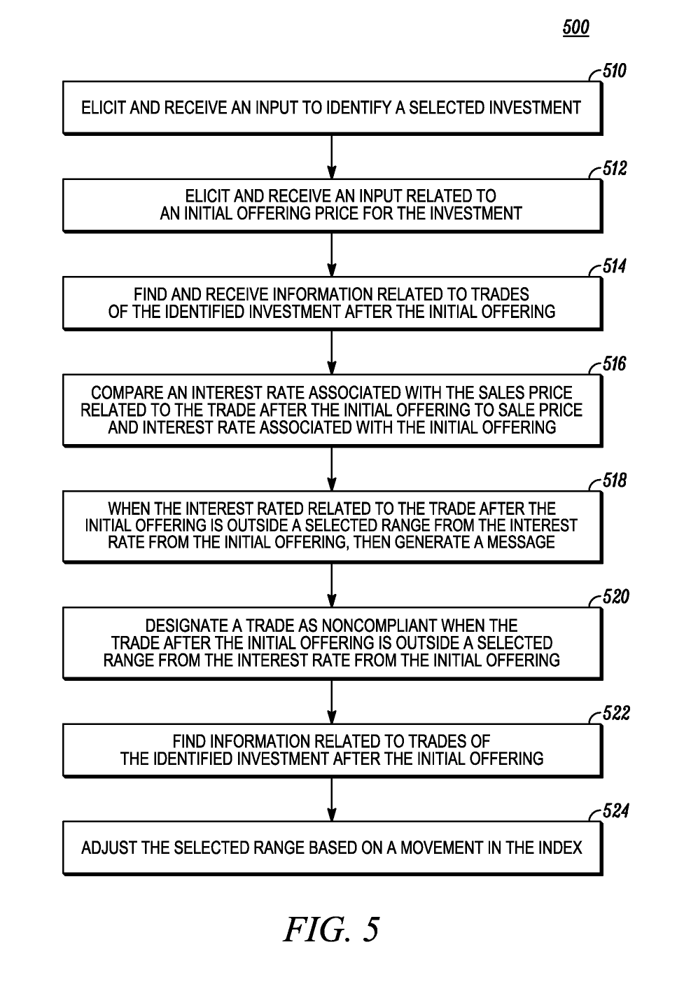

FIG. 5 is a flow diagram of a method 500 associated with the computer system 200 (shown in FIG. 2) or the computer system 2000 (shown in FIG. 1), according to an example embodiment. The computerized method 500 illustrates an example of the operation of the computer system 200, 2000. The computerized method 500 includes eliciting and receiving an input to identify a selected investment 510, and eliciting and receiving an input related to an initial offering price for the investment 512. The computerized method 500 also includes finding and receiving information related to trades of the identified investment after the initial offering 514. Finding and receiving information related to the trades of the initial investment 514 includes monitoring the investment as it trades in the secondary market. The trades can be monitored using the investment identifier or investment identifiers elicited by the eliciting and receiving module 220. The computer system 200 is attached to the internet 202. More specifically, the computer system 200 monitors a data base in a computing system also attached to the internet. For example, one such data base for bonds is called EMMA and is available at http://emma.msrb.org/. The eliciting and receiving module 220 receives data related to a sale of an investment in the secondary market. The data is monitored for a selected time period, such as from the initial sale date associated with the initial offering to the closing date or some other day near the closing date for the initial offering. After the information is received, the computerized method 500 includes comparing an interest rate associated with the sales price related to the trade after the initial offering to sale price and interest rate associated with the initial offering 516. The interest rate is determined from the sales price, the amount of principal, and the cash flow from the investment over time. Given these parameters, an interest rate can be determined.

When the interest rated related to the trade after the initial offering is outside a selected range from the interest rate from the initial offering, the computerized method includes generating a message 518. The selected range can be set in any way. In one embodiment, the range is calculated using a rule. In still another embodiment, a rule is set forth and determined as in Appendix A, of this patent application.

The computerized method can also include designating a trade as noncompliant when the trade after the initial offering is outside a selected range from the interest rate from the initial offering 520. The method 500 also includes finding information related to trades of the identified investment after the initial offering 522. For example, one information related to the trade can be the interest rate of an index to which the interest rate of the investment is tied. For example, if the interest rate to be paid depends on another interest rate, then this information is useful in explaining at least a portion of an interest rate movement associated with a sale in the secondary market. The information is received and the microprocessor and memory of the computer system are used to adjust the selected range based on a movement in the index 524. For example, if the index rate drops, then the interest rate of the payout over time from the investment will also drop. This can be used to explain at least, in part, a variance in the interest rate.

The computerized method 500 can be programmed into a memory of a general purpose computer to form a special purpose machine. The special purpose machine can be totally dedicated to executing the computerized method or just a portion of the general purpose machine can form the special purpose machine. The method 500 programmed into a memory of a general purpose computer is in the form of a non transitory set of instructions.

A computer operating system runs a computer, and executes a computerized method 500 that includes eliciting and receiving an input to identify a selected investment, as well as an initial offering price for the investment. The operating system also finds and receives information related to trades of the identified investment after the initial offering and compares transactional information related to the trade after the initial offering to transactional information from the initial offering. The operating system generates a message when the transactional information related to the trade after the initial offering is outside a selected range from the transactional information from the initial offering. In some embodiments, the transactional information related to the initial offering includes the initial offering sale price, and the transactional information related to the trade after the initial offering includes the trading price in a secondary market. Generating a message includes evaluating if the sales price of a trade after the initial offering is outside a selected range from the price of the investment at the initial offering. In still other embodiments, the computer operating system elicits and receives information related to a benchmark interest rate to which the interest rate of the initial offering depends, to determine if the benchmark interest rate has moved between the time of the initial offering and the time of the subsequent sale. If there has been movement, the computer operating system calculates a market adjusted price for the initial offering based on movement of the benchmark interest rate, and evaluates if the subsequent sales price is outside a selected range from the market adjusted price. In some embodiments, the operating system also includes determining an amount of the subsequent sales price that is attributable to movement in the benchmark interest rate. In some embodiments, the computer operating system also generates a list of actions to be taken when the subsequent sale price is outside the selected range of the sale price at issuance. In still further embodiments, the computer operating system also generates a report for a selected period of time that includes transactions after the initial offering of an investment that are outside a selected range of the initial offering price. The computer operating system can also generate and transmit an invoice.

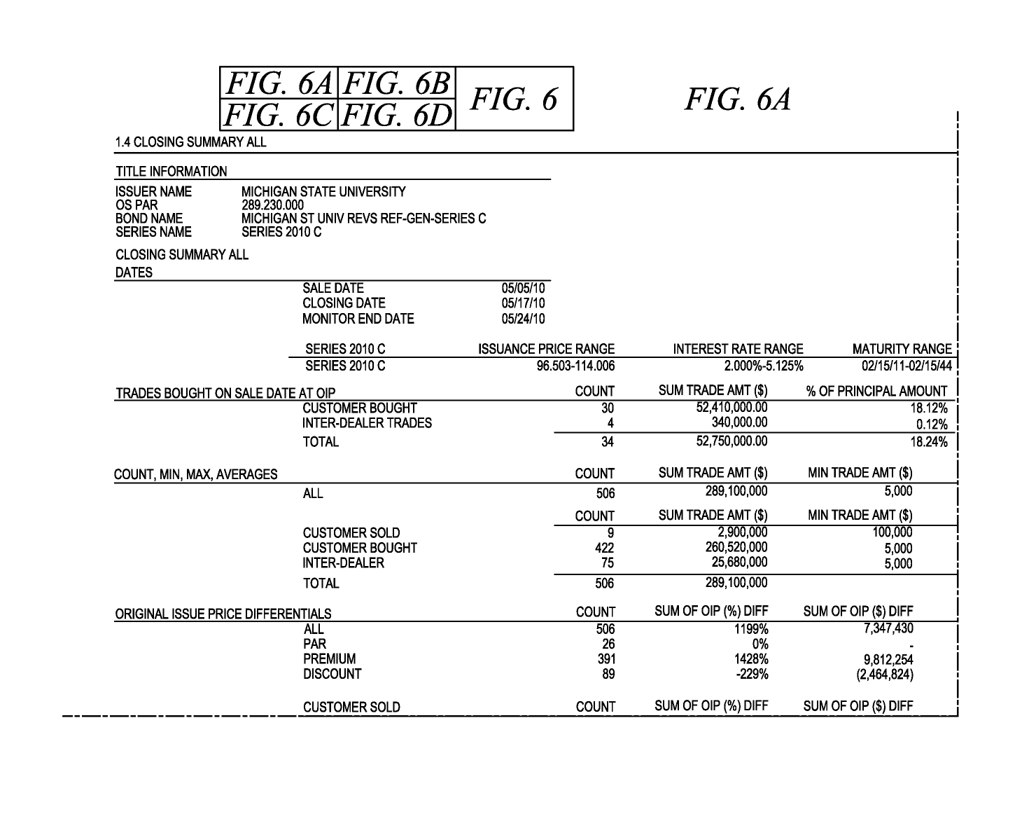

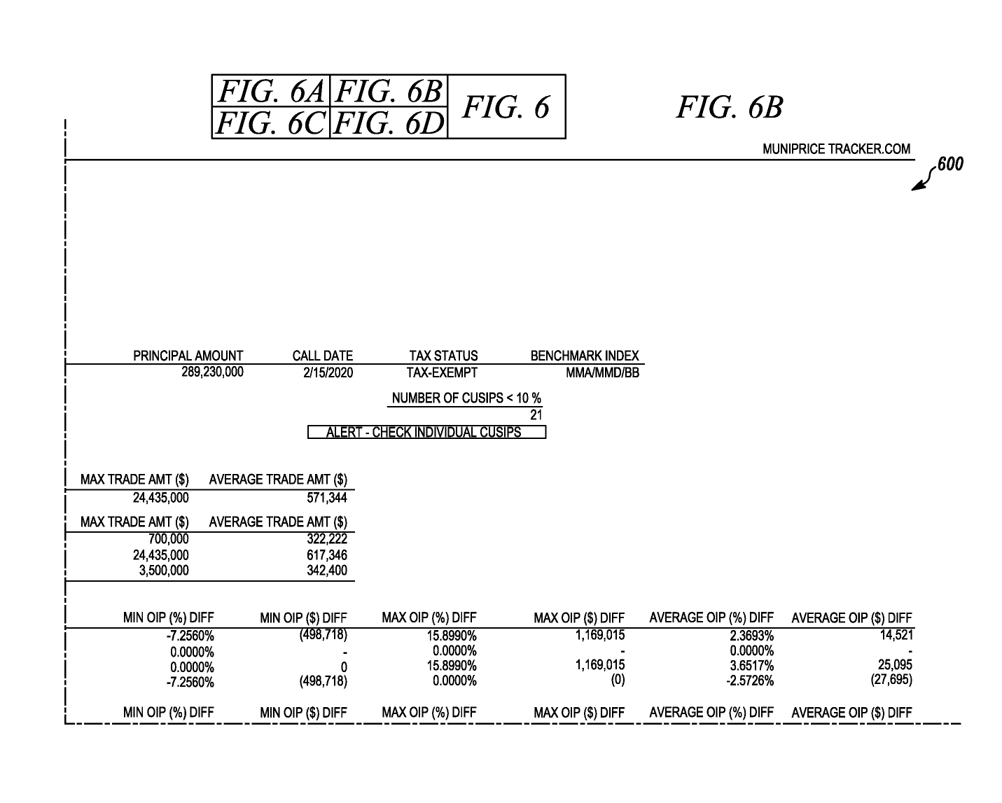

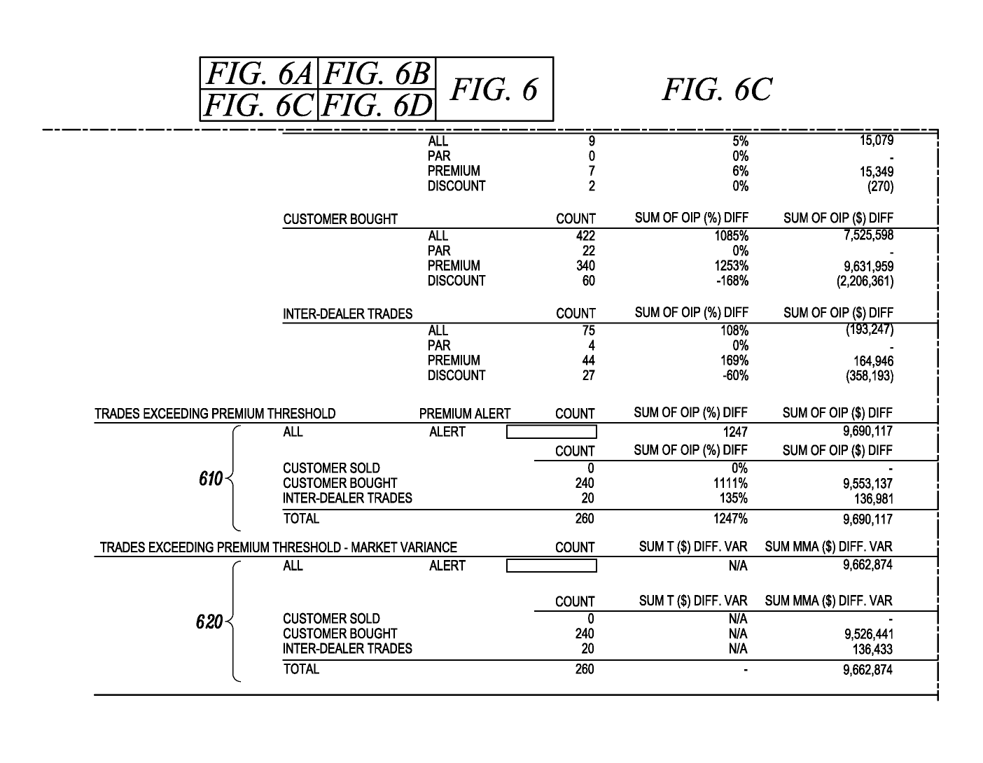

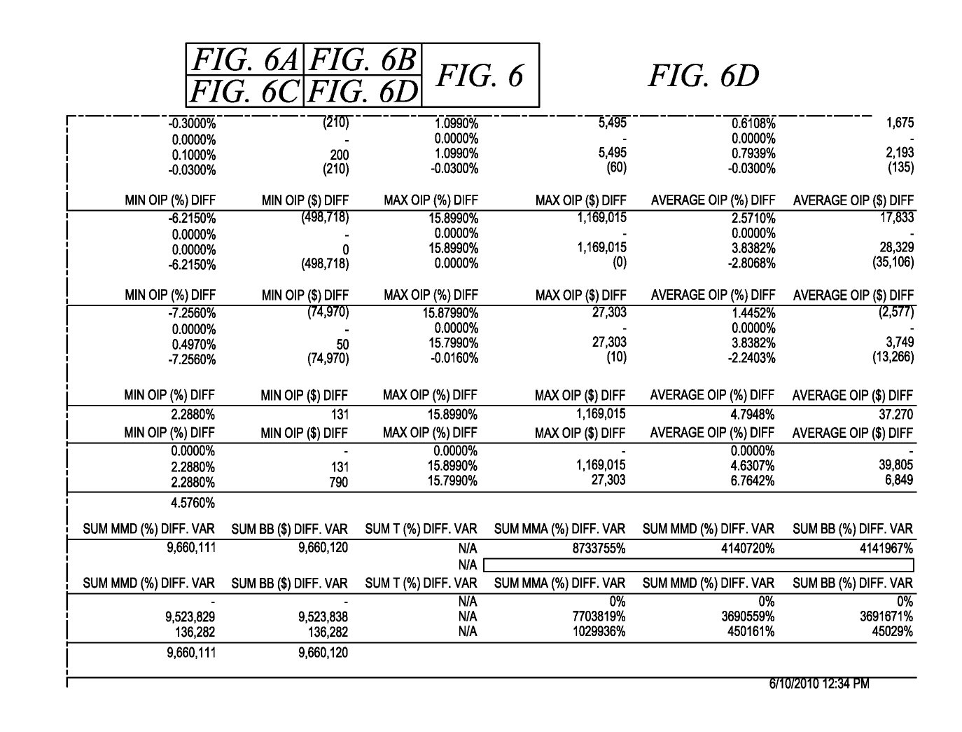

FIG. 6 is a screen shot 600 of a portion of a report which the operating system of the computer 200 generates at a selected time. The portion of the report shown in the screen shot 600 is a summary portion. The report includes a record of all trades made in one or more secondary markets that involved the investment. The report is for the selected time period, such as from the date of the initial offering to a date just before closing. The report also includes a summary which identifies a number of trades that occurred which were outside the selected range of the initial interest rate under the summary heading of “Trades Exceeding Premium Threshold” 610. Of course the final report allows access to details of these trades. In addition, the summary page also includes a subset of those which is also outside an adjusted interest rate given that an index, to which the investment is tied, moved over the period of interest. These trades are included in the summary as “Trades Exceeding Premium Threshold-Market Variance” 620. Of course all of the information on which the summary is based is provided in the final report.

In some embodiments, once the final report is completed, an invoice is auto generated. This can be maintained on the website. The client can choose the billing frequency and identify contact information for anyone else that needs to receive the invoice. The invoices will then, based on activity each billing period, automatically be e-mailed to the client, identified company contact and any other contacts the client input (e.g. trustee). An e-mail should also be sent directly to the person responsible for ensuring that payment has been received. In some embodiments, an invoice is generated per CUSIP for direct billing to the trustee who is in charge of handling and distributing the funds at the closing of the investment. In this way, the entity monitoring the secondary market and providing the service can ensure that it can be paid on the closing date.

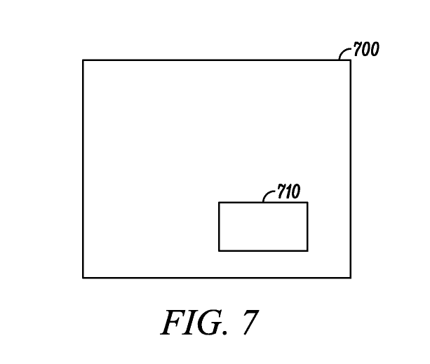

FIG. 7 is a schematic drawing of a machine readable medium 700 that includes an instruction set 710, according to an example embodiment. The machine-readable medium 700 that provides instructions 710 that, when executed by a machine, cause the machine to perform operations including eliciting and receiving an input to identify a selected investment, and eliciting and receiving an initial offering price for the investment. The machine readable medium 700 also includes instructions for finding and receiving information related to trades of the identified investment after an initial offering, comparing transactional information related to the trade after the initial offering to transactional information from the initial offering, and generating a message when the transactional information related to the trade after the initial offering is outside a selected range from the transactional information from the initial offering. In some embodiments, the machine-readable medium 700 also provides instructions 710 that, when executed by a machine, further cause the machine to elicit and receive information related to a benchmark interest rate to which the interest rate of the initial offering depends, and to determine if the benchmark interest rate has moved between the time of the initial offering and the time of the subsequent sale. In still further embodiments, the machine-readable medium 700 provides instructions 710 that, when executed by a machine, further cause the machine to perform operations that further include calculating a market adjusted price for the initial offering based on movement of the benchmark interest rate; and evaluating if the subsequent sales price is outside a selected range from the market adjusted price. Once the trade set up is done, it should then automatically go to a notifications set up screen. This should show the applicable notification triggers. It should also allow the user to set up 5 different E-mail addresses which can receive the notifications on each CUSIP.

The present disclosure refers to instructions that are received at a memory system. Instructions can include an operational command, e.g., read, write, erase, refresh, etc., an address at which an operational command should be performed, and the data, if any, associated with a command. The instructions can also include error correction data.

In some example embodiments, data from a database of prices of investments in a secondary market can be used to guide or set the issuance price of an investment, such as a bond. This is especially useful in instances where there have not been many issuances of comparable securities. In many instances, in advance of a sale of a bond by a tax-exempt issuer or a taxable issuers, financial advisors gather recent bond sale price/yield data to support a price proposal by an underwriter. This data is typically limited to primary issuance “comparables”, issued by peer institutions. When peers have not issued bonds in a sufficient numbers over a selected, recent time frame, an information gap in the appropriate price can exist. The information gap causes municipal issuers to be price takers versus price negotiators.

In one example embodiment, the information gap can be closed by reviewing secondary market price information on EMMA. To be useful, the EMMA data has to be organized, aggregated and the data needs to be ranked with the functionality of summary statistics. EMMA data, as available from the website______, is only marginally useful. Having readily available organized, summarized and query-able price information converts the EMMA data into useful price information to assist tax-exempt and taxable issuers in the process of primary issuance negotiations.

In purchasing bonds, the primary and secondary market investors of tax-exempt and taxable bond issuer have various methods of ascertaining the relative value of a bond. Price-talk amongst underwriters and buyers, and holders and buyers among themselves, typically centers on spreads to various indexes, and absolute and relative return. As compared to issuers, investors have a relative advantage as demonstrated by the fact that prices for bonds in secondary market prices almost always exceed issuance prices, allowing commissions and profits to be earned, prior to bonds settling into buy and hold accounts.

The private sector driven by ever increasing efficiencies will appreciate having systematic and organized price information for determining fair-value and indentifying profit opportunities.

The sample list of statistics and system of organized price information that will serve both constituencies as follows:
1. Spread to index at time of sale in the primary market.
2. Spread to index at time of sale of peer institution primary market sales, (within a proximate time period—as defined by the user)
3. Secondary market prices and yields for peer institutions, (within a proximate time period—as defined by the user)
4. Distribution of secondary market prices and summary statistics
5. Graphical representation of spreads, indices, secondary market prices, scatter diagram.
6. User defined comparable maturities
7. User defined comparable call features
8. User defined time periods.
9. User defined peers.
10. System ranked peer groups defined by system users

Investment banks and underwriters of municipal bonds frequently utilize issuance volume rankings of bond sales to demonstrate industry leadership to attract new clients and retain old clients. Relative performance of volume rankings speaks little to the execution performance of delivering the most efficient bond sale for the benefit of the issuer and investor alike.

In one example embodiment, additional rankings can be added to volume ranking of investment banks and underwriters in order to form an enhanced system of ranking investment banks and underwriters. The enhanced system, in one example embodiment, is designed utilizing price information from EMMA. EMMA information can be aggregated and summarized so as to evaluate on price performance versus volume issuance. These additional rankings provide useful information for investors.

A sample list of rankings that can be performed is as follows:
1) Lowest yields by sector, issuer type and issuer rating, maturity and call features and volume statistics.
2) Ranking of spreads to primary market yields by sector, issuer type and issuer rating, maturity and call features and volume statistics.
3) Lowest spread between issuance yields and average secondary market yields during a specified time period (closing period)
4) Lowest combined of 1 and 2 above as well as volume.

Of course, other rankings can be formed from the EMMA data. The above rankings will serve two purposes: It will allow municipal issuers to evaluate underwriters that will deliver the lowest cost financing to their borrowings, and it will allow investors to identify underwriters who deliver the most profit opportunity. When investors are provided with this additional ranking data, they can become smarter investors and make better decisions.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A computer operating system that runs a computer, the computer operating system executing a computerized method comprising:
eliciting and receiving an input to identify a selected investment;
eliciting and receiving an initial offering price for the investment;
finding and receiving information related to trades of the identified investment after the initial offering;
comparing transactional information related to the trade after the initial offering to transactional information from the initial offering; and
generating a message when the transactional information related to the trade after the initial offering is outside a selected range from the transactional information from the initial offering.

2. The computer operating system of claim 1 wherein the transactional information related to the initial offering includes the initial offering sale price, and wherein the transactional information related to the trade after the initial offering includes the trading price in a secondary market.

3. The computer operating system of claim 2 wherein generating a message includes evaluating if the sales price of a trade after the initial offering is outside a selected range from the price of the investment at the initial offering.

4. The computer operating system of claim 1 further comprising:
eliciting and receiving information related to a benchmark interest rate to which the interest rate of the initial offering depends; and
determining if the benchmark interest rate has moved between the time of the initial offering and the time of the subsequent sale.

5. The computer operating system of claim 4 further comprising:
calculating a market adjusted price for the initial offering based on movement of the benchmark interest rate; and
evaluating if the subsequent sales price is outside a selected range from the market adjusted price.

6. The computer operating system of claim 4 further comprising:
calculating a market adjusted price for the initial offering based on movement of the benchmark interest rate;
evaluating if the subsequent sales price is outside a selected range from the market adjusted price; and
determining an amount of the subsequent sales price that is attributable to movement in the benchmark interest rate.

7. The computer operating system of claim 1 further comprising generating a list of actions to be taken when the subsequent sale price is outside the selected range of the sale price at issuance.

8. The computer operating system of claim 1 further comprising generating a report for a selected period of time that includes transactions after the initial offering of an investment that are outside a selected range of the initial offering price.

9. The computer operating system of claim 1 further comprising generating and transmitting an invoice for performing the elements of claim 8.

10. A computerized method comprising:
eliciting and receiving an input to identify a selected investment;
eliciting and receiving an input related to an initial offering price for the investment;
finding and receiving information related to trades of the identified investment after the initial offering;
comparing a sales price related to the trade after the initial offering to sale price associated with the initial offering; and
generating a message when the sales price related to the trade after the initial offering is outside a selected range from the sales price from the initial offering.

11. The computerized method of claim 10 wherein eliciting and receiving an input related to an initial public offering includes providing at least one drop down menu on a computer interface.

12. The computerized method of claim 10 wherein eliciting and receiving an input related to an initial public offering includes providing at least one blank field that is required to be filled on a computer interface.

13. The computerized method of claim 10 further comprising designating a trade as noncompliant when the trade after the initial offering is outside a selected range from the sales price from the initial offering.

14. The computerized method of claim 10 further comprising finding information related to trades of the identified investment after the initial offering.

15. The computerized method of claim 10 further comprising:
receiving information related to an index to which a rate of return for the investment; and
adjusting the selected range based on a movement in the index.

16. The computerized method of claim 10 programmed into a memory of a general purpose computer to form a special purpose machine.

17. The computerized method of claim 10 wherein the method programmed into a memory of a general purpose computer is in the form of a non transitory set of instructions.

18. A system for identifying non compliant trades after for a selected time after an initial offering comprising:
a processor;
a memory communicatively coupled to the processor;
an eliciting and receiving information module using the processor and the memory to elicit and receive information to identify a selected investment, and to elicit and receive information regarding an initial offering price for the investment;
a module for determining and receiving information related to at least one trade of the identified investment after an initial offering;
a compare module for comparing transactional information related to the trade after the initial offering to the initial offering price; and
a message generation module using the processor and the memory when the transactional information related to the trade after the initial offering is outside a range from the initial offering.

19. The system for identifying non compliant trades after for a selected time after an initial offering of claim 18 further comprising:
a module for monitoring an index on which an interest rate of the selected investment depends; and
a module for adjusting the initial offering price based on a change in the interest rated of the selected investment.

20. A machine-readable medium that provides instructions that, when executed by a machine, cause the machine to perform operations comprising:
eliciting and receiving an input to identify a selected investment;
eliciting and receiving an initial offering price for the investment;
finding and receiving information related to trades of the identified investment after an initial offering;
comparing transactional information related to the trade after the initial offering to transactional information from the initial offering; and
generating a message when the transactional information related to the trade after the initial offering is outside a selected range from the transactional information from the initial offering.

21. The machine-readable medium of claim 20 that provides instructions that, when executed by a machine, further cause the machine to elicit and receive information related to a benchmark interest rate to which the interest rate of the initial offering depends; and
to determine if the benchmark interest rate has moved between the time of the initial offering and the time of the subsequent sale.

22. The machine-readable medium of claim 21 that provides instructions that, when executed by a machine, further cause the machine to perform operations that further comprise:
calculating a market adjusted price for the initial offering based on movement of the benchmark interest rate; and
evaluating if the subsequent sales price is outside a selected range from the market adjusted price.
